(19) United States
(12) Patent Application Publication
(10) Pub. No.: US 2011/0262277 A1
(43) Pub. Date: Oct. 27, 2011

(54) GAS TURBINE COMPOSITE WORKPIECE TO BE USED IN GAS TURBINE ENGINE

(75) Inventors: Roger Sjöqvist, Trollhattan (SE); Dan Gustafsson, Bralanda (SE); Hasse Lindell, Trollhattan (SE)

(73) Assignee: VOLVO AERO CORPORATION, Trollhattan (SE)

(21) Appl. No.: 13/140,463

(22) PCT Filed: Dec. 18, 2008
(86) PCT No.: PCT/SE2008/000733

§ 371 Date: Jun. 20, 2011

(51) Int. Cl. F01D 5/30; B23P 15/04

(52) U.S. Cl. 416/213 R; 29/889.2

(57) ABSTRACT

A gas turbine composite workpiece, such as a workpiece forming a part of a gas turbine casing, is provided. The workpiece includes at least two components joined by at least one weld seam. In order to reduce thermal stresses of the workpiece during operation, the weld seam is interrupted by at least one aperture. In order to reduce the exchange of gases between the workpiece's sides, the workpiece may be equipped with an arrangement for preventing gas flow through the aperture.

### BACKGROUND AND SUMMARY

The invention relates to a gas turbine composite workpiece comprising least two components joined by at least one weld seam. Specifically, the invention relates to a composite exhaust casing of a gas turbine engine. Moreover, the invention relates to a method of manufacturing a composite workpiece comprising at least two components joined by at least one weld seam.

Gas turbine engines are known to take in air at a relatively low speed, heat it up by combustion and expel it at a much higher speed. Such gas turbine engines comprise stators with an outer and an inner ring, the outer ring connected to the inner ring by wall elements (struts) arranged between the rings. Gas turbine parts may be made by casting in one single piece. Alternatively, the parts may be made up of multiple pieces joined together by welding. As an example, US 2006/0000077 A1 discloses a stator part for a gas engine which is made up of several sectors which are joined together in the direction of its circumference. The sectors are cast as separate pieces, positioned adjacent to each other and welded one to another.

The individual sectors will typically comprise areas of different wall thickness. As the sectors are joined together by butt welding, weld seams joining areas of different wall thickness may meet or intersect. As gas turbine stator parts are subject to large thermal wear and large temperature gradients during operation, thermal stress may occur, especially in areas exhibiting weld seam crossings. This stress may cause deformations, material wear and eventually failure of the gas turbine parts.

It is desirable to reduce thermal stress in a gas turbine composite workpiece made up of several components joined by weld seams. More specifically, it is desirable to provide a composite exhaust casing for a gas turbine which is robust with respect to thermal wear. Furthermore, it is desirable to provide a method of manufacturing a gas turbine composite workpiece with reduced thermal stress.

According to an aspect of the invention, the gas turbine composite workpiece is made up of two or more components joined by weld seams and contains apertures which are located on the weld seams joining the components of the workpiece; the apertures are positioned in such a way that they interrupt the weld seams. The apertures relieve the thermal stresses building up in the area of the weld seams whenever the workpiece is subjected to large thermal gradients, thus reducing thermal stress within the gas turbine composite workpiece.

The components are particularly components forming at least a part of an annular structure in a gas turbine which annular structure is subject to high thermal load during operation. Particularly, whereas in the art of jet engines a 360 degree casting is used e.g. for the hub due to the complexity of this part, the present invention can provide a “fabricated hub” with components welded together which allows for a better manufacturability of the workpiece.

In order to form a closed workpiece surface and prevent gas exchange between the workpiece's sides during operation, the workpiece can be equipped with means for preventing gas flow through the aperture. Preferably, the means for preventing gas flow through the aperture can be formed by a bracket which blocks said aperture at least partly. The bracket may comprise two overlapping blades, each blade being attached to one of the adjacent components, for example by screws.

The gas turbine composite workpiece may comprise weld seams which intersect. These weld seam intersections constitute areas in which thermal stresses are likely to accumulate, thus causing increased local thermal wear during operation. Therefore, it is advantageous to place apertures at these weld seam intersections. In particular, each of the components of the gas turbine composite workpiece may comprise areas of different wall thickness, and the weld seams may be distributed over areas of varying wall thickness. In this case, since weld seams in these regions are especially subject to thermal stress and strain during operation of the workpiece, the apertures are preferably located in regions in which large variations of wall thickness occur.

In a preferred embodiment of the invention, the components of the workpiece are joined by butt welding. The butt weld seams joining thin-walled areas are preferably formed by laser welding, whereas the butt weld seams joining the thick-walled areas are preferably formed by electron beam welding.

The gas turbine composite workpiece may have a disk-like or ring-like shape. In that case, the components are sectors of the disk or the ring and are joined in the circumferential and/or radial direction of the disk or the ring. When used on a workDiece that forms part of a gas turbine, for example a turbine exhaust casing, an aspect of the invention thus enables an assembly with optimized weld seams experiencing reduced thermal stress during operation.

According to a second aspect of the invention, a method for manufacturing a gas turbine composite workpiece comprising least two components joined by at least one weld seam is provided. The method comprises the steps of (1) positioning the components next to each other, (2) joining the components by a weld seam and (3) machining the workpiece in an area comprising at least one end portion of the weld seam, thus at least partly removing the end portion of the weld seam. Preferably, the workpiece is machined in such a way as to generate or modify an aperture located at the end portion of the weld seam. The end portion can be a starting point or an end point of the weld seam.

In a preferred embodiment, the components comprise recesses located adjacent to the end of a weld seam; after welding, the area of the recesses is machined in such a way that the end portion of the weld seam is removed. In a further preferred embodiment, the components comprise protrusions which, after welding, accommodate the end portion of the weld seam; after welding, the area of the protrusion is machined in such a way that the end portion of the weld seam is removed.

After welding the components together and machining the weld seams, the composite can be welded to a support structure. The components may form a fabricated hub of the gas turbine composite workpiece.

### BRIEF DESCRIPTION OF THE DRAWINGS

The present invention together with the above-mentioned and other objects and advantages may best be understood from the following detailed description of the embodiments, but not restricted to the embodiments, wherein is shown schematically:

FIG. 1a-1c a perspective front view of a gas turbine composite workpiece corresponding to a preferred embodiment of the invention (FIG. 1a), a detailed view a region 1b of the workpiece of FIG. 1a (FIG. 1b) and a detailed view a region Ic of the workpiece of FIG. 1b exhibiting a thermal stress release aperture (FIG. 1c);

FIG. 2a-2b a perspective front view of a sector of the workpiece of FIG. 1a (FIG. 2a and a back view of a joining region Mb of the sector shown in FIG. 2a (FIG. 2b);

FIG. 3a-3d a schematic view a region III of the workpiece of FIG. 1c before welding (FIG. 3a); the workpiece region of FIG. 3a after welding of core region (FIG. 3b); the workpiece region of FIG. 3b after welding of rim region (FIG. 3c) and a view of the workpiece region of FIG. 3c as seen from direction 111d in FIG. 3c (FIG. 3d);

FIG. 4a-4d detailed views of the region depicted in FIG. 1c, exhibiting a bracket blocking the thermal stress release aperture: a front view of the bracket blocking the aperture (FIG. 4a), a back view of the aperture blocked by the bracket (FIG. 4b) and a sectional view corresponding to a cutting plane IVc-IVc of FIG. 4a (FIG. 4c), and a sectional view corresponding to a cutting plane IVId-IVd of FIG. 4a (FIG. 4d).

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of aspects of the invention and therefore should not be considered as limiting the scope of the invention.

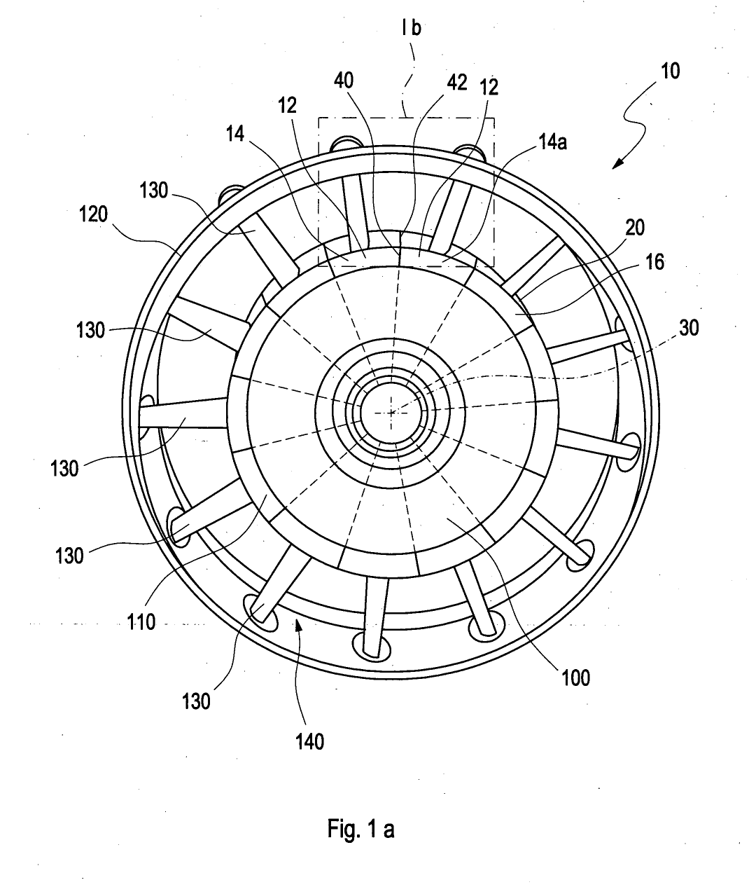

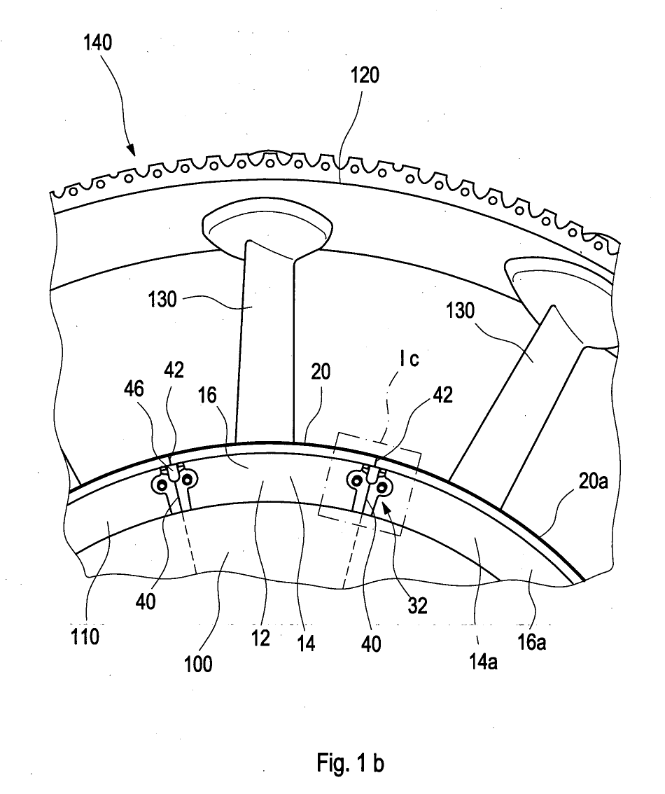

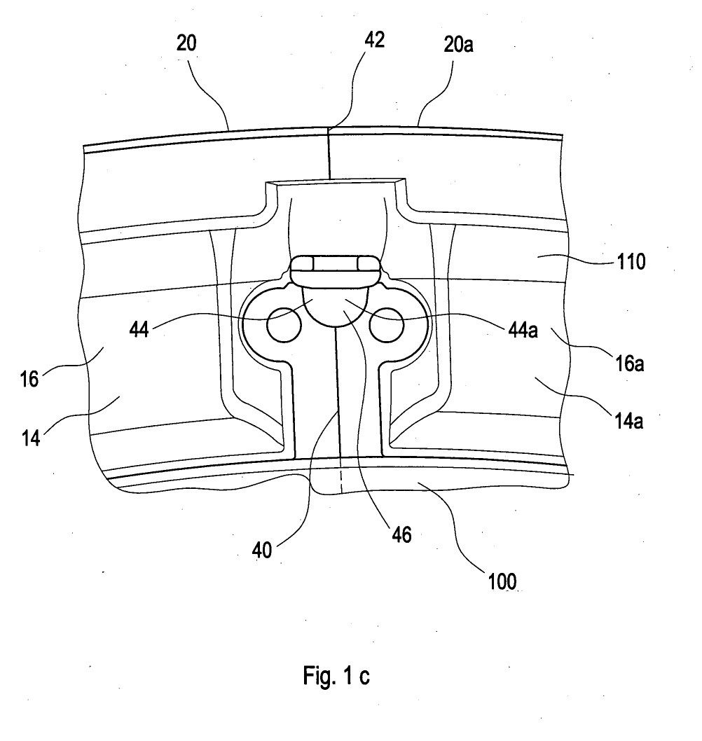

FIG. 1a shows a front view of a gas turbine composite workpiece 10 according to a preferred embodiment of the invention. The gas turbine composite workpiece 10 forms part of a turbine engine, particularly a rear frame for a jet engine. Typically, rear frames have different names depending on the specific manufacturer, such as e.g. “tail bearing house”, “turbine rear frame”, “turbine exhaust case” and the like. The main purpose of such a rear frame component e.g. in a plane is to act as a support for a shaft connecting the inlet fan to the low pressure turbine and to provide a rear mount of the engine to the plane usually by mount links connected to the pylon under the wing of the plane. The bearing is located at the centre bore with axis 30. The “ears” (not referred to with reference numerals) projecting radially away from the outside of the outer ring 120 are so called rear mount lugs used for engine mount attachment.

The structure 140 surrounding the main gas path is known as “ring-strut-ring” structure. The radial spokes 130 are usually called “vanes” if their purpose is to deflect air and “struts” if their purpose is to carry structural loads. The outer ring 120 is called “shroud” whereas the inner ring 110 is called “hub”. The “ring-strut-ring” structure 140 is connected to the bearings using a support structure 100 usually by a “support cone” represented by components 12. On multiple shaft engines, the centre bore can be used for multiple bearings.

The “ring-strut-ring” structure 140 is connected to the support structure 100 by a circumferential weld between these two parts.

In the art of jet engines a 360 degree casting is used for the hub 110 due to the complexity of this part. In contradistinction to this, the invention is particularly related to a “fabricated hub” with a multitude of components 12 welded together. In this example, thirteen components 12 are welded together and form the hub 110. The number of pieces is arbitrary but may be governed by the number of spokes 130 in the specific application. The components 12 forming the hub 110 are welded to form a 360 degree part. The weld seams are indicated by solid lines 40.

The support structure 100 can be made of one piece or of a multitude of pieces, for instance of as many pieces as the components 12. If a one-piece support structure 100 is used, the weld 40 (FIG. 1b) between the components 12 will stop at the circumferential support cone weld. Alternatively, the support structure 100 may be segmented as indicated by the broken lines in consistence with the weld seams 40 in the hub 110.

Specifically, the gas turbine composite workpiece 10 can be an intake part, an intermediate housing, a turbine exhaust housing (i.e. a terminating housing part) etc. for a gas turbine. The workpiece 10 may be used as a support for bearings, thus transferring loads and providing ducts for gases.

The gas turbine composite workpiece 10 exhibits radial symmetry about the axis 30 and is made up of several (in the present case thirteen) identical components 12, as indicated by solid and dotted lines in FIG. 1a and FIG. 1b.

The components 12 are hub portions forming sectors 14, 14a in the hub ring 110 of the radially symmetrical workpiece 10. In a preferred embodiment of the invention, the sectors 14 are manufactured by casting, e.g. by investment casting.

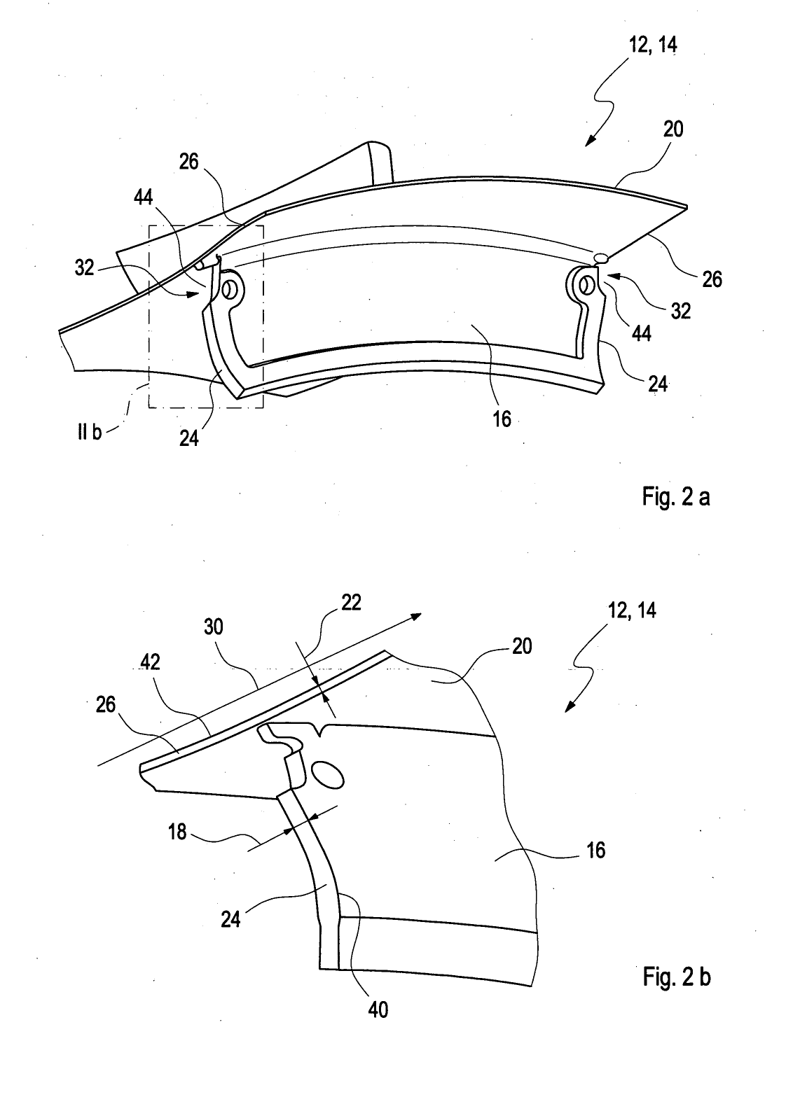

Each sector 14 comprises a core area 16 of large wall thickness 18 (e.g. 6-7 mm) extending in radial direction of the workpiece 10 as well as a rim area 20 of smaller wall thickness 22 (e.g. 2-3 mm) extending out from the core area 16 in an axial direction of the workpiece 10. FIGS. 2a and 2b show detailed views of the rim region 20 as well as part of the core region 16 of sector 14. The core region 16 and the rim region 20 of each sector 14 are delimited by edges 24, 26. During the manufacture of the gas turbine composite workpiece 10, the sectors 14 are placed side by side circumferentially so that the edges 24, 24a and 26, 26a of neighbouring components sectors 14, 14a face each other, and the sectors 14, 14a are welded one to another by butt welding. As is evident from FIG. 2a, weld seams 40 following edges 24 (i.e. joining the core regions 16, 16a of adjacent sectors 14, 14a) and weld seams 42 following edges 26 (i.e. joining the rim regions 20, 20a of adjacent sectors 14, 14a) will intersect in a region 32 in which the thin-walled rim area 20 meets the thick-walled core area 16. When the gas turbine composite workpiece 10 is subjected to large thermal gradients during operation, this region 32 of intersecting welds will encounter large thermal stress. In order to alleviate this local thermal stress, the intersection region 32 is provided with an aperture 46.

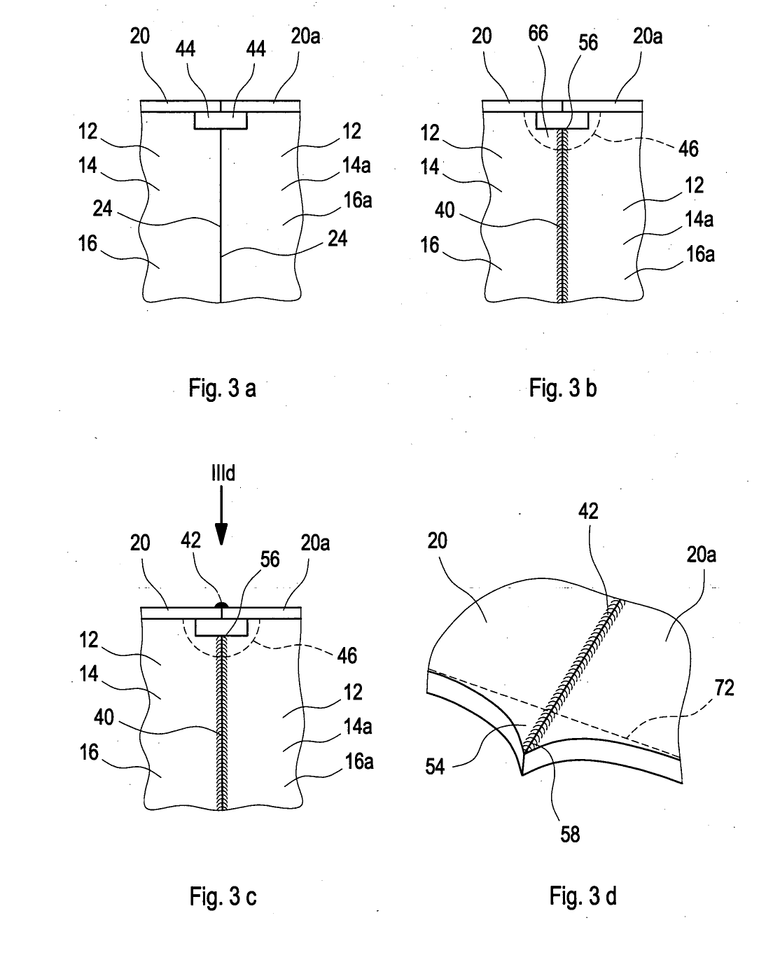

FIG. 3a shows a schematic view of two components 12 (sectors 14, 14a) placed next to each other in such a way that the edges 24, 24a that are to be joined are positioned side by side. Note that the components 12 exhibit recesses 44 located in a region 32 in which the edges 24, 24a terminate. These recesses 44 enable the welding tool used for joining the components 12 to better access the cramped space in which the component's core region 16 meets the rim region 20. As the components 12 are welded together, a weld seam 40 following edges 24, 24a is generated (see FIG. 3b). Weld seam 40 ends in a bump at the end portion 56 of the weld seam 40 protruding into the recesses 44. The end portion 56 can be the starting point or the end point of the weld seam 40. In order to remove the bump at the end portion 56 of weld seam 40, an area 66 of the components 12 comprising the bump at the end portion 56 of weld seam 40 is machined (e.g. by drilling or milling), thereby remove the bump and—preferably—also part of the components 12; this will result in an aperture 46 (dotted line in FIG. 3b) with a smooth edge extending from sector 14 to sector 14a, thus eliminating any adverse effect of the end portion 56 (bump) of the weld seam 40.

In the schematic of FIG. 3b, the aperture 46 is oval, whereas in the embodiment of FIGS. 2a and 2b, the aperture 46 has a rounded T-shape; in principle, the aperture 46 can have any shape. As the sectors 14, 14a are welded together to form the gas turbine composite workpiece 10, their individual recesses 44 coincide in such a way as to facilitate welding, and after welding the end portions 56 of the weld seams 40 are machined off, forming a number of apertures 46 between the sectors 14, 14a, the number of apertures 46 corresponding to the number of individual sectors 14, 14a of the workpiece 10.

Analogously to the welding of the core region 16 of the sectors 14, 14a, the rims 20, 20a are joined by weld seam 42, as is schematically depicted in FIGS. 3c and 3d. Preferably, the rim areas 20, 20a exhibit protrusions 54 extending axially from the sectors 14, 14a. As the weld seam 42 is placed, the beginning and end portions of the weld seam 42 will be located on the protrusions 54; after welding, the protrusions 54 will be machined off (e.g. by turning or milling), thus removing the end portions 58 of the weld seam 42 and generating a smooth edge of the rim 20 (dotted line 72 in FIG. 3d). The end portions 58 can be the starting point of the end point of the weld seam 42.

As can be seen from FIG. 1c, the aperture 46 is located in the intersection region 32 of weld seam 40 following the edge 24 of the core area 16 and weld seam 42 following the edge 26 of the rim area 20. During operation of the gas turbine, the gas turbine composite workpiece 10 is subjected to considerable thermal gradients due to large temperature differences between the workpiece's 10 high-temperature and low-temperature sides. The machined apertures 46, ensuring smoothly finished ends of the weld seams 40, relieve the thermal stresses accumulating in the workpiece 10, especially in the intersection areas 32 where weld seams 40, 42 meet, thus considerably reducing the thermal stress and fatigue experienced by the workpiece 10 during operation.

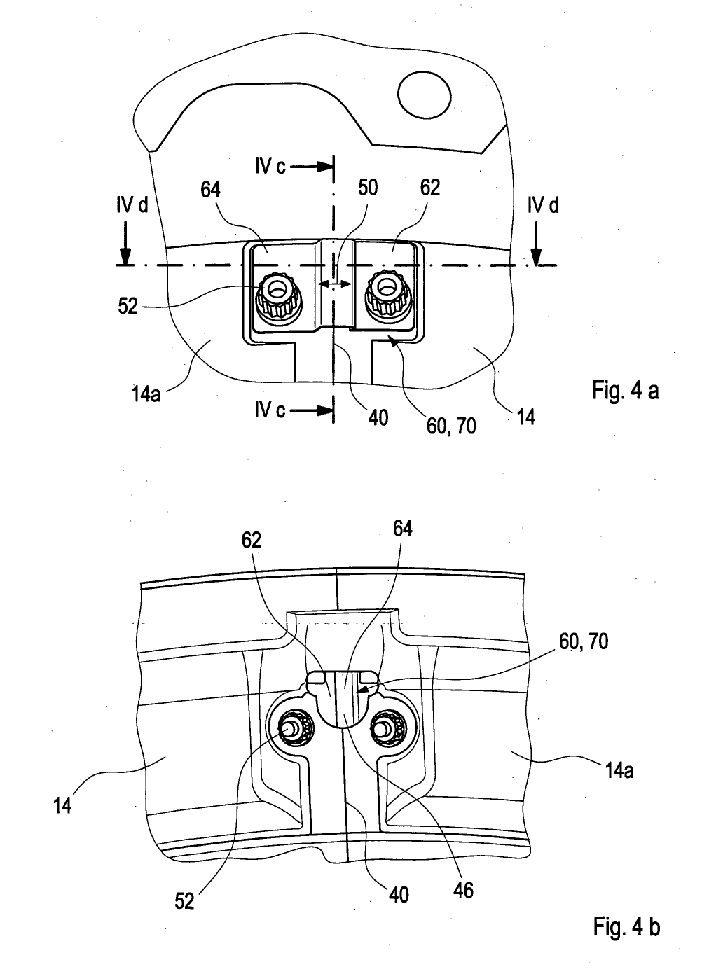

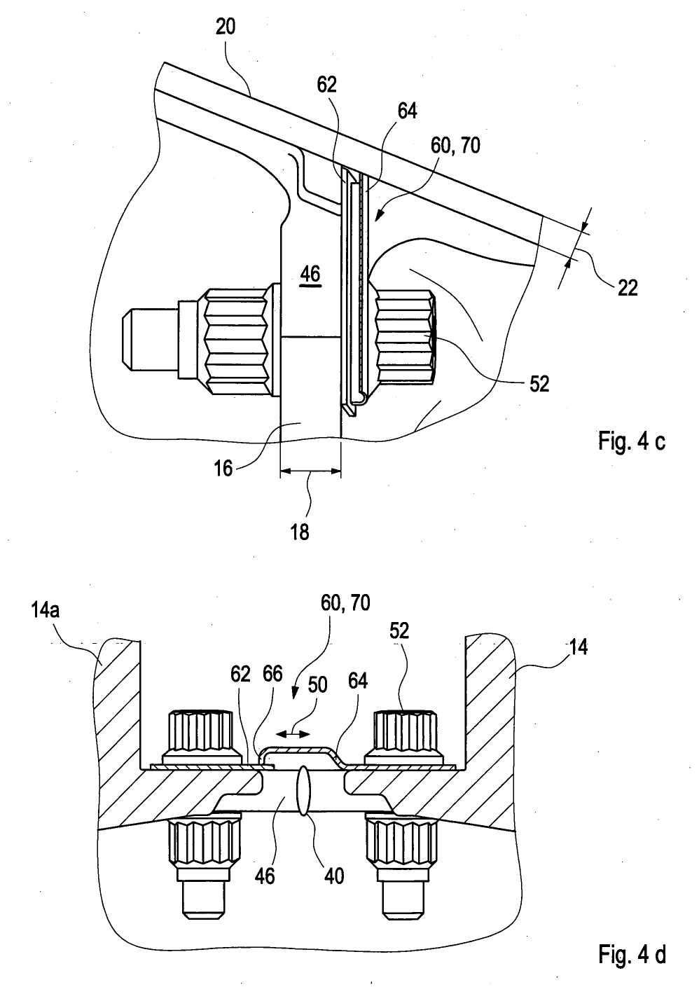

In order to minimize an exchange of gas between the high-temperature and the low-temperature sides of the workpiece 10 during operation, the apertures 46 are provided with means 70 for preventing undesired gas flow through these apertures 46. In the preferred embodiment shown in FIGS. 4a-4c, the apertures 46 are blocked by brackets 60 blocking the apertures 46. In principle, these brackets 60 could be formed by a single sheet attached on both sides to the sectors 14, 14a; in this case, however, it would be deformed by the thermal wear and may eventually fail. In order to avoid this, the bracket 60 is designed to comprise two overlapping blades 62, 64 fastened to two adjacent sectors 14, 14a by means of bolts or screws 52. Blade 62 extends only partly into the aperture 46, at most up to the weld bead of weld seam 40. Blade 64 spans the aperture 46 and is arched in such a way that it overlaps the weld bead of weld seam 40. The far edge 66 of blade 64 rests upon blade 62, thus forming a small, well-defined leak between the workpiece's front and back side. This leak enhances the effect of the aperture 46 as a relief for thermally induced stress. As the workpiece 10 undergoes thermal expansion and contraction, the far edge 66 of blade 64 will slide on top of blade 62 (arrow 50 in FIG. 4a), Thus compensating thermally induced elongations.

Besides using a bracket 60 for preventing undesired gas flow through the apertures 46, the apertures could also be blocked by different means, such as by applying a seal, a cover or an alternate suitably shaped blocking member.

In a preferred embodiment, the gas turbine composite workpiece 10 is manufactured in the following way: In a first step, the sectors 14, 14a forming the workpiece 10 are placed adjacent to each other. Subsequently, adjacent rim areas 20, 20a of neighbouring sectors 14, 14a are joined by laser or TIG welding, the weld seams 42 following the edges 26, 26a extending in axial direction 30. In this way, by joining the thirteen sectors 314, 14a of FIG. 1a, a hoop is formed. Afterwards, the radial welds 40 are applied, following the edges 24, 24a extending in radial direction. Since the wall thickness 18 of the core areas 16, 16a are much larger than the rim areas 20, 2Oa1 the welding methods used on the rim areas 20, 20a do not furnish good results; rather, the core areas 16, 16a are joined by electron beam welded. After applying the welds 42 and 40, end portions 56, 58 of the weld seams 40, 42 are removed by machining as described in conjunction with FIGS. 3a to 3d. Finally, the apertures 46 formed in the intersection areas 32 are provided with means 70 for blocking gas exchange through the apertures, preferably by blocking them with brackets 60 with blades 62, 64.

1. A gas turbine composite workpiece (10) comprising least two components (12, 14, 14a), particularly constituting hub portions, joined by at least one weld seam (40, 42), characterized in that the weld seam (40, 42) is interrupted by at least one aperture (46) of the gas turbine composite workpiece (10).

2. The gas turbine composite workpiece according to claim 1, characterized in that the aperture (46) is arranged at one end portion (56) of the weld seam (40).

3. The gas turbine composite workpiece according to claim 1 or 2, characterized in that the aperture (46) is positioned in a border area of the workpiece (10).

4. The gas turbine composite workpiece according to any preceding claim, characterized in that the weld seams (40, 42) are butt weld seams.

5. The gas turbine composite workpiece according to any preceding claim, characterized by being equipped with means (70) for preventing gas flow through the aperture (46).

6. The gas turbine composite workpiece according to claim 5, characterized in that the means (70) for preventing gas flow through the aperture (46) are formed by a bracket (60) which blocks said aperture (46) at least partly.

7. The gas turbine composite workpiece according to claim 6, characterized in that the bracket (60) comprises two overlapping blades (62, 64), each blade (62, 64) being attached to one of the adjacent components (14, 14a).

8. The gas turbine composite workpiece according to claim 7, characterized in that the blades (62, 64) are removably attached to the components (12, 14, 14a)

9. The gas turbine composite workpiece according to claim 8, characterized in that the blades (62, 64) are attached to the components (12, 14, 14a) by means of mechanical fastening means, notably by screws (52).

10. The gas turbine composite workpiece according to any preceding claim, characterized by comprising intersecting weld seams (40, 42) and that the aperture (46) is located at an intersection (32) of two weld seams (40, 42).

11. The gas turbine composite workpiece according to any preceding claim, characterized in that
each component (12, 14) is made up of two or more areas (16, 20) of different wall thickness (18, 22),
the weld seams (40, 42) are located in at least two areas (16, 20) of different wall thickness (18, 22), and
the aperture (46) is located between adjacent weld seams (40, 42) joining areas (16, 20) of different wall thickness (18, 22).

12. The gas turbine composite workpiece according to claim 11, characterized in that the weld seams (42) joining thin-walled areas (20) are formed by laser welding or TIG welding whereas the weld seams (40) joining thick-walled areas (16) are formed by electron beam welding.

13. The gas turbine composite workpiece according to any preceding claim, characterized by having a disk-like or ring-like shape and that the components (12) are sectors (14, 14a) joined with weld seams (40) running in radial direction as well as with weld seams (42) running in axial direction.

14. The gas turbine composite workpiece according to any preceding claim, characterized by forming a part of a gas turbine.

15. Annular structure which is subject to thermal load comprising one or more gas turbine composite workpieces (10) according to one of the preceding claims.

16. A method for manufacturing a gas turbine composite workpiece (10) comprising least two components (12, 14, 14a), particularly constituting hub portions, joined by at least one weld seam (40, 42), the method comprising the steps of
positioning the components (12, 14, 14a) next to each other;
joining the components (12, 14, 14a) by a weld seam (40, 42);
machining the workpiece (10) in an area (66, 54) comprising at least one end portion (56, 58) of the weld seam (40, 42).

17. The method according to claim 16, characterized in that the workpiece (10) is machined in such a way as to generate or modify an aperture (46) located at the end portion (56) of the weld seam (40).

18. The method according to claim 16 or 17, characterized in that the components (12, 14, 14a) comprise recesses (44) adjacent to the end portion (56) of the weld seam (40), and that, after welding, the area (66) of the recesses (44) is machined in such a way as to remove the end portion (56) of the weld seam (40).

19. The method according to one of the claims 16 to 18, characterized in that the components (12, 14, 14a) comprise protrusions (54) for accommodating, the end portion (58) of the weld seam (42), and that, after welding, the protrusions (54) are machined in such a way as to remove the end portion (58) of the weld seam (42).

20. The method according to one of the claims 16 to 10, characterized in that the welded components (12, 14, 14a) are forming a ring (110) which is welded to a support structure (100) with a circumferential weld.

21. A gas turbine composite workpiece comprising least two components joined by at least one weld seam, wherein the weld seam is interrupted by at least one aperture of the gas turbine composite workpiece.

22. The gas turbine composite workpiece according to claim 21, wherein the aperture is arranged at one end portion of the weld seam.

23. The gas turbine composite workpiece according to claim 21 or 22, wherein the aperture is positioned in a border area of the workpiece.

24. The gas turbine composite workpiece according to claim 21, wherein the weld seams are butt weld seams.

25. The gas turbine composite workpiece according to claim 21, being equipped with means for preventing gas flow through the aperture.

26. The gas turbine composite workpiece according to claim 25, wherein the means for preventing gas flow through the aperture are formed by a bracket which blocks said aperture at least partly.

27. The gas turbine composite workpiece according to claim 26, wherein the bracket comprises two overlapping blades, each blade being attached to one of the adjacent components.

28. The gas turbine composite workpiece according to claim 27, wherein the blades are removably attached to the components.

29. The gas turbine composite workpiece according to claim 28, wherein the blades are attached to the components by means of mechanical fastening means, notably by screws.

30. The gas turbine composite workpiece according to claim 21, comprising intersecting weld seams and wherein the aperture is located at an intersection of two weld seams.

31. The gas turbine composite workpiece according to claim 21, wherein
each component is made up of two or more areas of different wall thickness,
the weld seams are located in at least two areas of different wall thickness, and
the aperture is located between adjacent weld seams joining areas of different wall thickness.

32. The gas turbine composite workpiece according to claim 31, wherein the weld seams joining thin-walled areas are formed by laser welding or TIG welding whereas the weld seams joining thick-walled areas are formed by electron beam welding.

33. The gas turbine composite workpiece according to claim 21, having a disk-like or ring-like shape and that the components are sectors joined with weld seams running in radial direction as well as with weld seams running in axial direction.

34. The gas turbine composite workpiece according to claim 21, forming a part of a gas turbine.

35. Annular structure which is subject to thermal load comprising one or more gas turbine composite workpieces according to claim 21.

36. A method for manufacturing a gas turbine composite workpiece comprising least two components joined by at least one weld seam, the method comprising the steps of
positioning the components next to each other;
joining the components by a weld seam;
machining the workpiece in an area comprising at least one end portion (56, 58) of the weld seam.

37. The method according to claim 36, wherein the workpiece is machined in such a way as to generate or modify an aperture located at the end portion of the weld seam.

38. The method according to claim 37, wherein the components comprise recesses adjacent to the end portion of the weld seam, and that, after welding, the area of the recesses is machined in such a way as to remove the end portion of the weld seam.

39. The method according to claim 37, wherein the components comprise protrusions for accommodating the end portion of the weld seam, and that, after welding, the protrusions are machined in such a way as to remove the end portion of the weld seam.

40. The method according to claim 37, wherein the welded components are forming a ring which is welded to a support structure with a circumferential weld.
